(19) United States
(12) Patent Application Publication
(10) Pub. No.: US 2014/0043285 A1
(43) Pub. Date: Feb. 13, 2014

(54) ACTIVE ELECTRONIC PAPER TOUCH APPARATUS

(71) Applicant: Yen-Hung Tu, (US)

(72) Inventors: Yen-Hung TU, Taipei (TW); Chung-Lin CHIA, Taipei (TW); Han-Chang CHEN, Taipei (TW)

(73) Assignee: Yen-Hung TU, Taipei (TW)

(21) Appl. No.: 13/751,625

(22) Filed: Jan. 28, 2013

(30) Foreign Application Priority Data
Aug. 10, 2012 (TW) 101128892

(51) Int. Cl. G06F 3/044

(52) U.S. Cl. CPC G06F 3/044
USPC 345/174

(57) ABSTRACT

An active electronic paper touch apparatus, including: a first electrode layer, having multiple first electrodes and multiple switch devices, wherein each of the multiple first electrodes is coupled with one of the multiple switch devices; an electronic paper display layer, located above the first electrode layer; a transparent electrode layer, located above the electronic paper display layer and having multiple transparent electrodes, wherein each of the multiple transparent electrodes opposes at least one of the multiple first electrodes; and a control unit, having a touch mode and an electronic paper mode, wherein, when in the touch mode, the control unit will have a touch sensing unit coupled between the first electrode layer and the transparent electrode layer to execute a capacitive touch detection procedure.

The current application claims a foreign priority to the patent application of Taiwan No. 101128892 filed on Aug. 10, 2012.

### BACKGROUND OF THE INVENTION

1. Field of the Invention

The present invention relates to a touch apparatus, especially to an active electronic paper touch apparatus, which can multiplex an active matrix electronic paper structure to execute an electronic paper image update procedure or a capacitive touch detection procedure.

2. Description of the Related Art

General button type touch apparatuses use mechanical buttons or resistive buttons as touch input means, and the top surfaces of the mechanical buttons or resistive buttons are generally attached or printed with symbols or figures for function indications.

However, the mechanical buttons or resistive buttons have the disadvantage of getting worn out easily. Besides, as the symbols or figures are generally fixed, a user cannot be sure whether it is working or not when he/she pushes the mechanical buttons or resistive buttons.

To solve the foregoing problems, a novel, endurable, and touch-responsive touch apparatus is therefore needed.

### SUMMARY OF THE INVENTION

One objective of the present invention is to disclose an active electronic paper touch apparatus, which can make use of a bi-stable display characteristic of electronic paper to provide display function and touch function simultaneously.

Another objective of the present invention is to disclose an active electronic paper touch apparatus, which can utilize two electrode layers of an active matrix electronic paper device to execute a self capacitive touch detection procedure or a mutual capacitive touch detection procedure.

Another objective of the present invention is to disclose an active electronic paper touch apparatus, which can utilize an electrode layer of an active matrix electronic paper device to execute a self capacitive touch detection procedure or a mutual capacitive touch detection procedure.

Still another objective of the present invention is to disclose an active electronic paper touch apparatus, which can alter a static touch figure in response to a touch input to facilitate a user to perform a touch operation.

To attain the foregoing objectives, an active electronic paper touch apparatus is proposed, including:

a first electrode layer, having multiple first electrodes and multiple switch devices, wherein each of the multiple first electrodes is coupled with one of the multiple switch devices;

an electronic paper display layer, located above the first electrode layer;

a transparent electrode layer, located above the electronic paper display layer and having multiple transparent electrodes, wherein each of the multiple transparent electrodes opposes at least one of the multiple first electrodes;

a control unit, having a touch mode and an electronic paper mode, wherein, when in the touch mode, the control unit will have a touch sensing unit coupled between the first electrode layer and the transparent electrode layer to execute a capacitive touch detection procedure; when in the electronic paper mode, the control unit will have an electronic paper voltage source coupled between the first electrode layer and the transparent electrode layer to execute an electronic paper image update procedure.

In one embodiment, the electronic paper display layer includes multiple micro capsules, multiple micro cups, or multiple rotatable balls.

In one embodiment, the touch sensing unit has a touch voltage source, and the voltage of the touch voltage source is not higher than the voltage of the electronic paper voltage source.

In one embodiment, the capacitive touch detection procedure includes a charging step, a charge redistribution step, and a comparison step.

In one embodiment, the capacitive touch detection procedure further includes a reverse bias step.

In one embodiment, the charging step has a first period, the electronic paper image update procedure has a second period, and the first period is not longer than the second period.

In one embodiment, the active electronic paper touch apparatus further includes a protective layer covering the transparent electrode layer, wherein the protective layer is made of a material selected from a group consisting of glass, polycarbonate, Polymethylmethacrylate, and Polyethylene Terephthalate.

In one embodiment, the first electrode layer is above a substrate.

In one embodiment, each of the multiple switch devices includes a thin film transistor.

To attain the foregoing objectives, the present invention further proposes an active electronic paper touch apparatus, including:

a first electrode layer, having multiple first electrodes and multiple switch devices, wherein each of the multiple first electrodes is coupled with one of the multiple switch devices;

an electronic paper display layer, located above the first electrode layer;

a transparent electrode layer, located above the electronic paper display layer and having multiple transparent strip electrodes, wherein each of the multiple transparent strip electrodes opposes at least one of the multiple first electrodes; and

a control unit, having a touch mode, wherein, when in the touch mode, the control unit will have a touch sensing unit coupled between the first electrode layer and the transparent electrode layer to execute a capacitive touch detection procedure, which is a procedure selected from a group consisting of a self capacitive touch detection procedure, a mutual capacitive touch detection procedure, and any combinations thereof.

In one embodiment, the electronic paper display layer includes multiple micro capsules, multiple micro cups, or multiple rotatable balls.

In one embodiment, the touch sensing unit has a touch voltage source of a first voltage, and the first voltage is not higher than a second voltage of an electronic paper voltage source.

In one embodiment, the self capacitive touch detection procedure includes a charging step, a charge redistribution step, and a comparison step; the mutual capacitive touch detection procedure includes a signal transmission step and a signal reception step.

In one embodiment, the capacitive touch detection procedure further includes a reverse bias step.

In one embodiment, the control unit further includes an electronic paper mode. When in the electronic paper mode, the control unit will have an electronic paper voltage source coupled between the first electrode layer and the transparent electrode layer to execute an electronic paper image update procedure, wherein the charging step has a first period, the electronic paper image update procedure has a second period, and the first period is not longer than the second period.

In one embodiment, the active electronic paper touch apparatus further includes a protective layer covering the transparent electrode layer, wherein the protective layer is made of a material selected from a group consisting of glass, polycarbonate, Polymethylmethacrylate, and Polyethylene Terephthalate.

In one embodiment, the first electrode layer is above a substrate.

In one embodiment, each of the multiple switch devices includes a thin film transistor.

To attain the foregoing objectives, the present invention further proposes an active electronic paper touch apparatus, including:

a first electrode layer, having multiple first electrodes and multiple switch devices, wherein each of the multiple first electrodes is coupled with one of the multiple switch devices;

an electronic paper display layer, located above the first electrode layer;

a transparent electrode layer, located above the electronic paper display layer and having multiple transparent triangular electrodes, wherein each of the multiple transparent triangular electrodes opposes at least one of the multiple first electrodes; and

a control unit, having a touch mode, wherein, when in the touch mode, the control unit will have a touch sensing unit coupled between the first electrode layer and the transparent electrode layer to execute a capacitive touch detection procedure, which is a procedure selected from a group consisting of a self capacitive touch detection procedure, a mutual capacitive touch detection procedure, and any combinations thereof.

In one embodiment, the electronic paper display layer includes multiple micro capsules, multiple micro cups, or multiple rotatable balls.

In one embodiment, the self capacitive touch detection procedure includes a charging step, a charge redistribution step, and a comparison step; the mutual capacitive touch detection procedure includes a signal transmission step and a signal reception step.

In one embodiment, the capacitive touch detection procedure further includes a reverse bias step.

To make it easier for our examiner to understand the objective of the invention, its structure, innovative features, and performance, we use preferred embodiments together with the accompanying drawings for the detailed description of the invention.

### BRIEF DESCRIPTION OF THE DRAWINGS

FIG. 1a illustrates an active electronic paper touch apparatus according to a preferred embodiment of the present invention.

FIG. 1b-1d illustrate the structures of the micro capsules, micro cups, and rotatable balls.

FIG. 2 illustrates a structure of a first electrode layer of FIG. 1a.

FIG. 3a illustrates an embodiment of a transparent electrode layer of FIG. 1a.

FIG. 3b illustrates another embodiment of the transparent electrode layer of FIG. 1a.

FIG. 3c illustrates a scenario where one transparent electrode of FIG. 3a opposes multiple first electrodes of FIG. 2.

FIG. 3d illustrates a scenario where one transparent electrode of FIG. 3b opposes multiple first electrodes of FIG. 2.

FIG. 3e illustrates a scenario where three first electrodes of FIG. 2 are connected electrically to form a capacitor with one transparent electrode of FIG. 3a for performing a self capacitive touch detection procedure.

FIG. 3f illustrates a scenario where three first electrodes of FIG. 2 are connected electrically to form a capacitor with one transparent electrode of FIG. 3a for performing a mutual capacitive touch detection procedure.

FIG. 3g illustrates a scenario where two neighboring transparent electrodes of FIG. 3a form a capacitor for performing a self capacitive touch detection procedure.

FIG. 3h illustrates a scenario where two neighboring transparent electrodes of FIG. 3a form a capacitor for performing a mutual capacitive touch detection procedure.

FIG. 4 illustrates another embodiment of the transparent electrode layer of FIG. 1a.

### DETAILED DESCRIPTION OF THE PREFERRED EMBODIMENTS

The present invention will be described in more detail hereinafter with reference to the accompanying drawings that show the preferred embodiments of the invention.

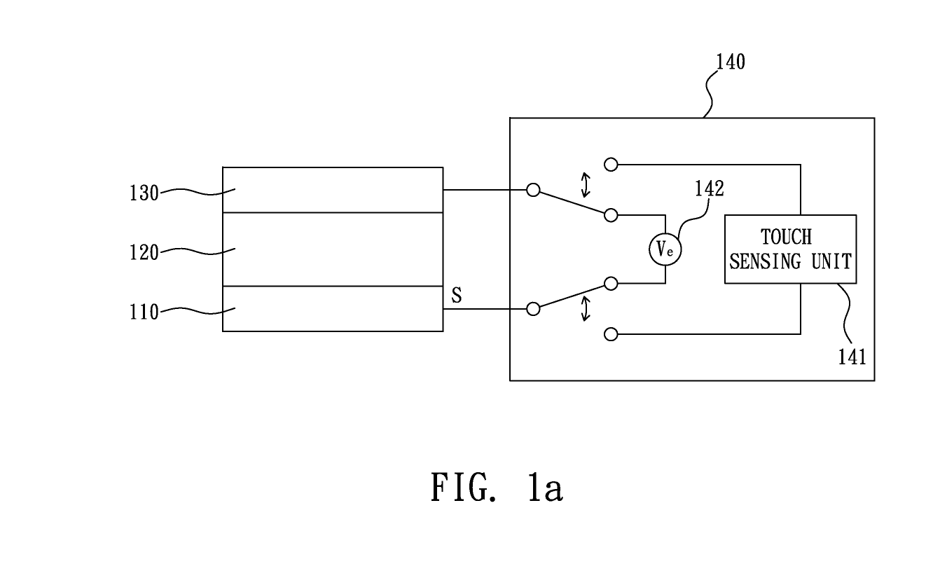

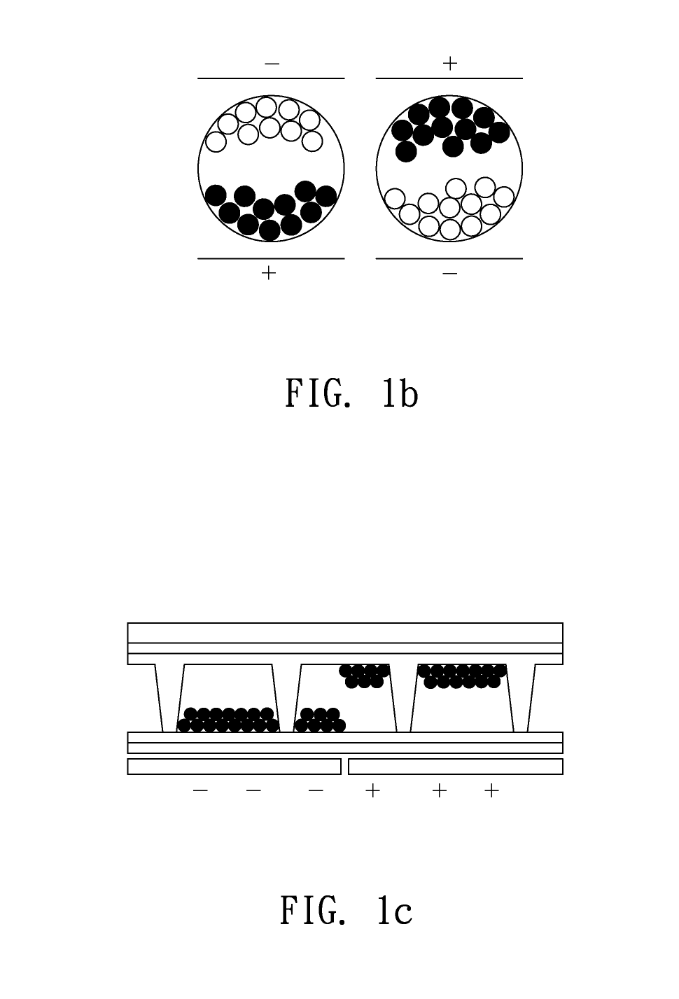

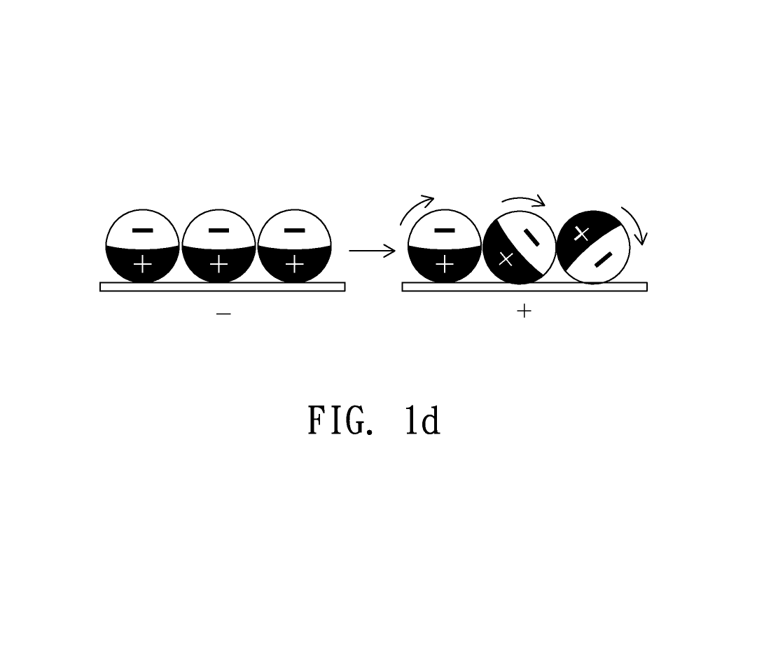

Please refer to FIG. 1a, which illustrates an active electronic paper touch apparatus according to a preferred embodiment of the present invention. As illustrated in FIG. 1a, the active electronic paper touch apparatus has a first electrode layer 110, an electronic paper display layer 120, a transparent electrode layer 130, and a control unit 140.

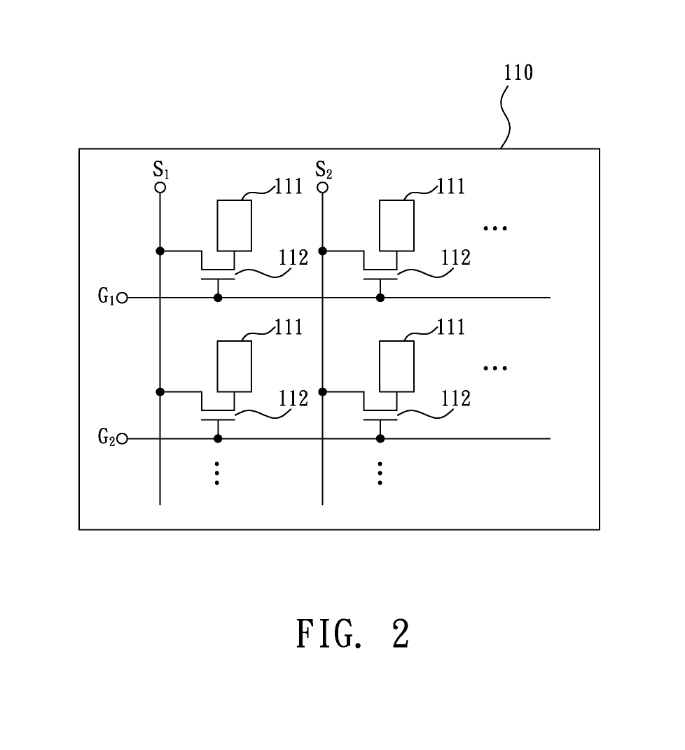

The first electrode layer 110, as illustrated in FIG. 2, has multiple first electrodes 111 and multiple switch devices 112, wherein, each of the multiple first electrodes 111 is coupled with one of the multiple switch devices 112. Each of the multiple switch devices 112 is preferably implemented with a thin film transistor, which has a source, a gate, and a drain, the drain coupled with one of the multiple first electrodes 111, the gate coupled with a gate driving line, and the source coupled with a source driving line. When the gate driving line is active—at a high voltage level, the source driving line will be in electric connection with one of the multiple first electrodes 111. Besides, the first electrode layer 110 can be located above a substrate (not shown in the figure).

The electronic paper display layer 120, located above the first electrode layer 110, can be a display layer having multiple micro capsules, a display layer having multiple micro cups, or a display layer having multiple rotatable balls. The structures of the micro capsules, micro cups, and rotatable balls are illustrated in FIG. 1b-1d.

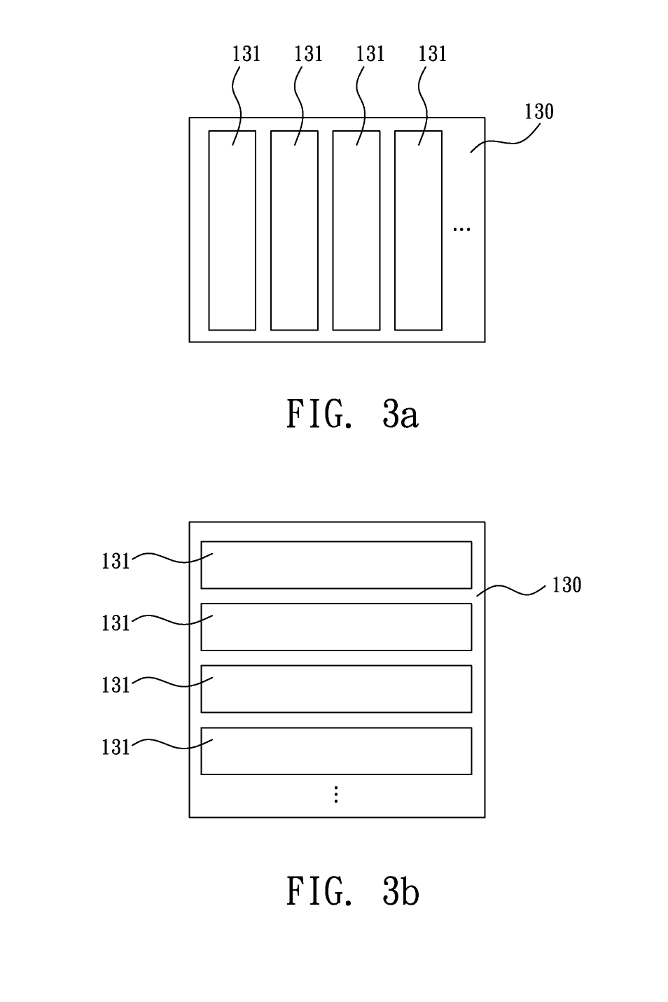

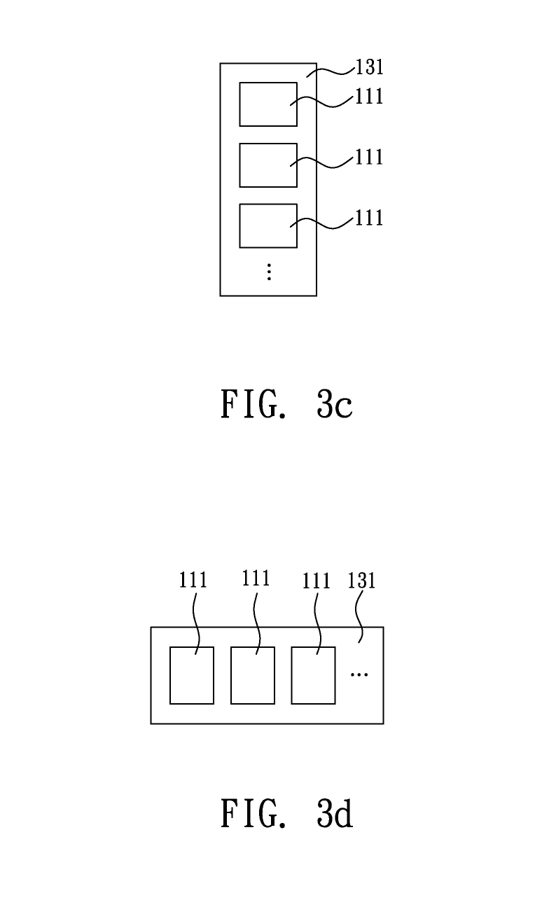

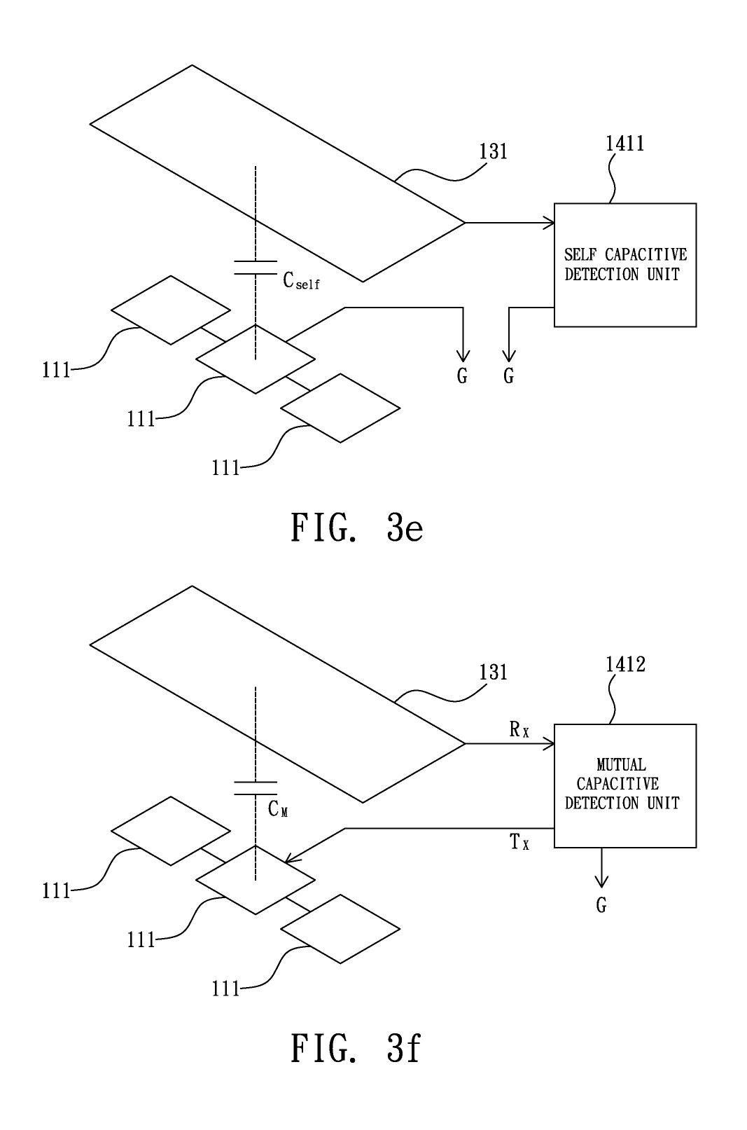

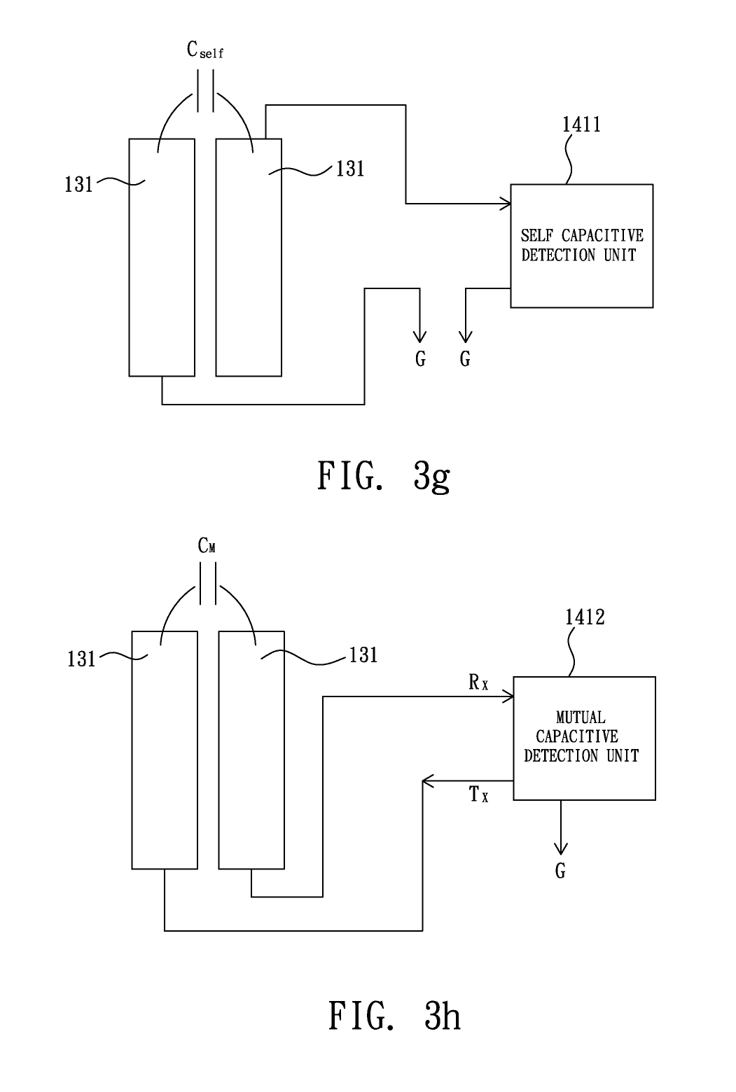

The transparent electrode layer 130, for example but not limited to a transparent ITO (Indium Tin Oxide) layer, is located above the electronic paper display layer 120 and has multiple transparent electrodes 131. The multiple transparent electrodes 131 each can be of rectangular shape, square shape, triangular shape, or round shape, etc. When the multiple transparent electrodes 131 each are of a rectangular shape, a length thereof can be perpendicular to the gate driving line—as illustrated in FIG. 3a, parallel to the gate driving line—as illustrated in FIG. 3b, or skew to the gate driving line. Besides, as illustrated in FIG. 3c-3d, each of the multiple transparent electrodes 131 opposes at least one of the multiple first electrodes 111.

The control unit 140, having a touch sensing unit 141 and an electronic paper voltage source 142, is capable of operating in a touch mode or an electronic paper mode. When in the touch mode, the control unit 140 will have the touch sensing unit 141 coupled between the first electrode layer 110 and the transparent electrode layer 130 to execute a capacitive touch detection procedure, so as to detect a touch operation; when in the electronic paper mode, the control unit 140 will have the electronic paper voltage source 142 coupled between the first electrode layer 110 and the transparent electrode layer 140 to execute an electronic paper image update procedure, so as to provide a display. The capacitive touch detection procedure can be a self capacitive touch detection procedure, a mutual capacitive touch detection procedure, or a combination thereof—for example, the self capacitive touch detection procedure executed before the mutual capacitive touch detection procedure.

Please refer to FIG. 3e, which illustrates a scenario where three of the multiple first electrodes 111 are connected electrically to correspond to one of the multiple transparent electrodes 131 to form a capacitor C_{self} for performing the self capacitive touch detection procedure. As illustrated in FIG. 3e, a self capacitive detection unit 1411—located in the touch sensing unit 141—is used to execute the self capacitive touch detection procedure, which includes a charging step, a charge redistribution step, and a comparison step. In the charging step, a touch voltage source (not illustrated in FIG. 3e) is used to charge the capacitor C_{self}. In the charge redistribution step, a charge-transfer capacitor (not illustrated in FIG. 3e) is in parallel with the capacitor C_{self}. In the comparison step, a voltage across the charge-transfer capacitor compares with a reference voltage (not illustrated in FIG. 3e). When a touch event occurs, the voltage across the charge-transfer capacitor will increase at a different speed, and the self capacitive detection unit 1411 can thereby detect a touch event taking place at one of the multiple transparent electrodes 131. As the charging step, the charge redistribution step, and the comparison step are known in prior art, they will not be addressed further.

The touch voltage source has a first voltage, the electronic paper voltage source 142 has a second voltage, and the first voltage is preferably not higher than the second voltage to avoid affecting a display of the electronic paper display layer 120.

The charging step has a first period, the electronic paper image update procedure has a second period, and the first period is preferably not longer than the second period to avoid affecting a display of the electronic paper display layer 120.

Preferably, the self capacitive touch detection procedure further includes a reverse bias step, which is to be executed after the comparison step to compensate the impact of the charging step on the electronic paper display layer 120. For example, when +5V is put across the first electrode layer 110 and the transparent electrode layer 130 in the charging step, −5V can be put across the first electrode layer 110 and the transparent electrode layer 130 in the reverse bias step.

Please refer to FIG. 3f, which illustrates a scenario where three of the multiple first electrodes 111 are connected electrically to correspond to one of the multiple transparent electrodes 131 to form a capacitor C_{M} for performing the mutual capacitive touch detection procedure. As illustrated in FIG. 3f, a mutual capacitive detection unit 1412—located in the touch sensing unit 141—is used to execute the mutual capacitive touch detection procedure, which includes a signal transmission step and a signal reception step. In the signal transmission step, a voltage signal T_{X} is sent to one end of the capacitor C_{M}. In the signal reception step, the mutual capacitive detection unit 1412 receives a sensed signal Rx from the other end of the capacitor C_{M}. The voltage of the sensed signal Rx can be altered by a touch event, and the mutual capacitive detection unit 1412 can thereby detect the touch event. As the mutual capacitive touch detection is known in prior art, it will not be addressed further.

Besides, the present invention can also use two neighboring ones of the multiple transparent electrodes 131 to perform the self capacitive touch detection procedure and the mutual capacitive touch detection procedure.

Please refer to FIG. 3g, which illustrates a scenario where two neighboring ones of the multiple transparent electrodes 131 form a capacitor C_{self} for performing the self capacitive touch detection procedure. As illustrated in FIG. 3g, the self capacitive detection unit 1411 is used to execute the self capacitive touch detection procedure on the capacitor C_{self}.

Please refer to FIG. 3h, which illustrates a scenario where two neighboring ones of the multiple transparent electrodes 131 form a capacitor C_{M} for performing the mutual capacitive touch detection procedure. As illustrated in FIG. 3h, the self capacitive detection unit 1412 is used to execute the mutual capacitive touch detection procedure on the capacitor C_{M}.

Preferably, the active electronic paper touch apparatus further includes a protective layer (not illustrated in the figure) covering the transparent electrode layer 140, wherein the protective layer is made of a material selected from a group consisting of glass, polycarbonate, Polymethylmethacrylate, and Polyethylene Terephthalate.

As a result, a touch symbol or figure can change in response to touch input to facilitate a user to perform a touch operation. For example, bar-lines can be altered in response to a volume touch operation, to inform a user of the status of the volume touch operation.

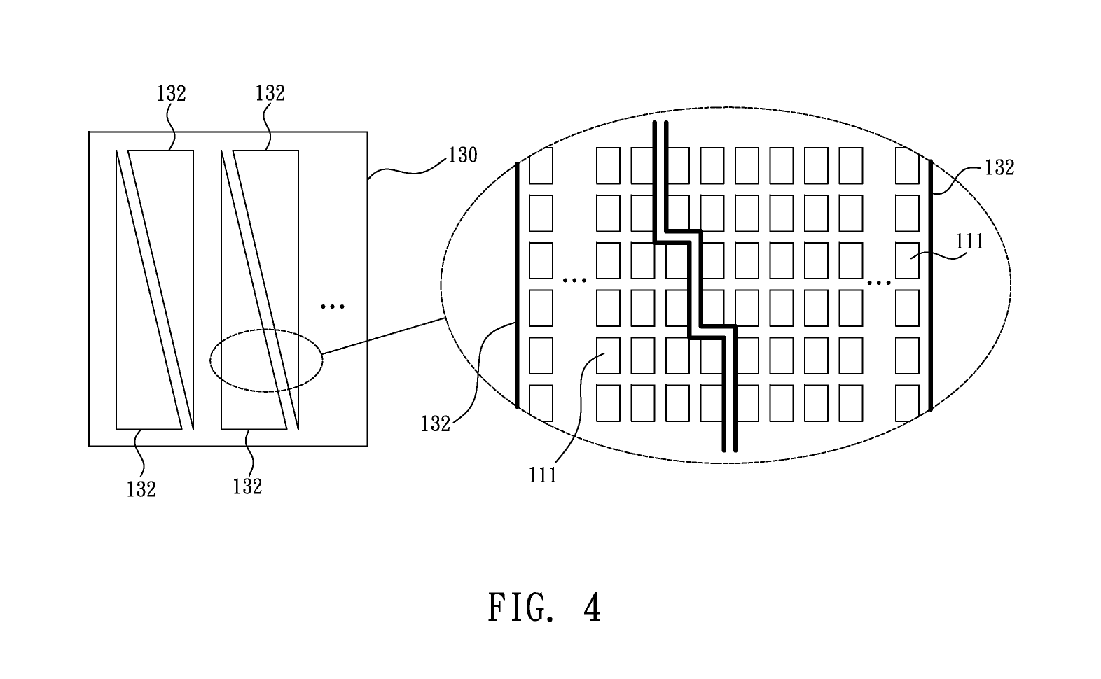

Besides, although the multiple transparent electrodes 131 of the transparent electrode layer 130 in FIG. 3a are of rectangular shape, other shapes can also be utilized. As illustrated in FIG. 4, the transparent electrode layer 130 has multiple transparent triangular electrodes 132, and each of the multiple transparent triangular electrodes 132 opposes at least one of the multiple first electrodes 111.

Thanks to the novel designs mentioned above, the present invention possesses the following advantages:

1. The active electronic paper touch apparatus of the present invention can make use of a bi-stable display characteristic of electronic paper to provide display function and touch function simultaneously.

2. The active electronic paper touch apparatus of the present invention can utilize two electrode layers of an active matrix electronic paper device to execute a self capacitive touch detection procedure or a mutual capacitive touch detection procedure.

3. The active electronic paper touch apparatus of the present invention can utilize an electrode layer of an active matrix electronic paper device to execute a self capacitive touch detection procedure or a mutual capacitive touch detection procedure.

4. The active electronic paper touch apparatus of the present invention can alter a static touch figure in response to a touch input to facilitate a user to perform a touch operation.

In conclusion, the active electronic paper touch apparatus of the present invention multiplexes an active matrix electronic paper structure to execute an electronic paper image update procedure or a capacitive touch detection procedure. In addition, the present invention makes use of the bi-stable characteristic of electronic paper to provide a static touch figure to facilitate a user to perform a touch operation. As a result, the present invention has made a break-through in touch apparatuses.

While the invention has been described by way of example and in terms of preferred embodiments, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

In summation of the above description, the present invention herein enhances the performance than the conventional structure and further complies with the patent application requirements and is submitted to the Patent and Trademark Office for review and granting of the commensurate patent rights.

What is claimed is:

1. An active electronic paper touch apparatus, comprising:
a first electrode layer, having multiple first electrodes and multiple switch devices, wherein each of said multiple first electrodes is coupled with one of said multiple switch devices;
an electronic paper display layer, located above said first electrode layer;
a transparent electrode layer, located above said electronic paper display layer and having multiple transparent electrodes, wherein each of said multiple transparent electrodes opposes at least one of said multiple first electrodes; and
a control unit, having a touch mode and an electronic paper mode, wherein, when in said touch mode, said control unit will have a touch sensing unit coupled between said first electrode layer and said transparent electrode layer to execute a capacitive touch detection procedure; when in said electronic paper mode, said control unit will have an electronic paper voltage source coupled between said first electrode layer and said transparent electrode layer to execute an electronic paper image update procedure.

2. The active electronic paper touch apparatus as disclosed in claim 1, wherein said electronic paper display layer includes multiple micro capsules, multiple micro cups, or multiple rotatable balls.

3. The active electronic paper touch apparatus as disclosed in claim 1, wherein said touch sensing unit has a touch voltage source of a first voltage, said electronic paper voltage source has a second voltage, and said first voltage is not higher than said second voltage.

4. The active electronic paper touch apparatus as disclosed in claim 1, wherein said capacitive touch detection procedure includes a charging step, a charge redistribution step, and a comparison step.

5. The active electronic paper touch apparatus as disclosed in claim 4, wherein said capacitive touch detection procedure further includes a reverse bias step.

6. The active electronic paper touch apparatus as disclosed in claim 4, wherein said charging step has a first period, said electronic paper image update procedure has a second period, and said first period is not longer than said second period.

7. The active electronic paper touch apparatus as disclosed in claim 1, further comprising a protective layer covering said transparent electrode layer, wherein said protective layer is made of a material selected from a group consisting of glass, polycarbonate, Polymethylmethacrylate, and Polyethylene Terephthalate.

8. The active electronic paper touch apparatus as disclosed in claim 1, wherein said first electrode layer is located above a substrate.

9. The active electronic paper touch apparatus as disclosed in claim 1, wherein each of said multiple switch devices includes a thin film transistor.

10. An active electronic paper touch apparatus, comprising:
a first electrode layer, having multiple first electrodes and multiple switch devices, wherein each of said multiple first electrodes is coupled with one of said multiple switch devices;
an electronic paper display layer, located above said first electrode layer;
a transparent electrode layer, located above said electronic paper display layer and having multiple transparent strip electrodes, wherein each of said multiple transparent strip electrodes opposes at least one of said multiple first electrodes; and
a control unit, having a touch mode, wherein, when in said touch mode, said control unit will have a touch sensing unit coupled between said first electrode layer and said transparent electrode layer to execute a capacitive touch detection procedure, which is a procedure selected from a group consisting of a self capacitive touch detection procedure, a mutual capacitive touch detection procedure, and any combinations thereof.

11. The active electronic paper touch apparatus as disclosed in claim 10, wherein said electronic paper display layer includes multiple micro capsules, multiple micro cups, or multiple rotatable balls.

12. The active electronic paper touch apparatus as disclosed in claim 10, wherein said touch sensing unit has a touch voltage source of a first voltage, and said first voltage is not higher than a second voltage of an electronic paper voltage source.

13. The active electronic paper touch apparatus as disclosed in claim 10, wherein said self capacitive touch detection procedure includes a charging step, a charge redistribution step, and a comparison step; said mutual capacitive touch detection procedure includes a signal transmission step and a signal reception step.

14. The active electronic paper touch apparatus as disclosed in claim 13, wherein said capacitive touch detection procedure further includes a reverse bias step.

15. The active electronic paper touch apparatus as disclosed in claim 13, wherein said control unit further comprises an electronic paper mode, and when in said electronic paper mode, said control unit will have an electronic paper voltage source coupled between said first electrode layer and said transparent electrode layer to execute an electronic paper image update procedure, wherein said charging step has a first period, said electronic paper image update procedure has a second period, and said first period is not longer than said second period.

16. The active electronic paper touch apparatus as disclosed in claim 10, further comprising a protective layer covering said transparent electrode layer, wherein said protective layer is made of a material selected from a group consisting of glass, polycarbonate, Polymethylmethacrylate, and Polyethylene Terephthalate.

17. The active electronic paper touch apparatus as disclosed in claim 10, wherein said first electrode layer is located above a substrate.

18. The active electronic paper touch apparatus as disclosed in claim 10, wherein each of said multiple switch devices includes a thin film transistor.

19. An active electronic paper touch apparatus, comprising:
a first electrode layer, having multiple first electrodes and multiple switch devices, wherein each of said multiple first electrodes is coupled with one of said multiple switch devices;
an electronic paper display layer, located above said first electrode layer;
a transparent electrode layer, located above said electronic paper display layer and having multiple transparent triangular electrodes, wherein each of said multiple transparent triangular electrodes opposes at least one of said multiple first electrodes; and
a control unit, having a touch mode, wherein, when in said touch mode, said control unit will have a touch sensing unit coupled between said first electrode layer and said transparent electrode layer to execute a capacitive touch detection procedure, which is a procedure selected from a group consisting of a self capacitive touch detection procedure, a mutual capacitive touch detection procedure, and any combinations thereof.

20. The active electronic paper touch apparatus as disclosed in claim 19, wherein said electronic paper display layer includes multiple micro capsules, multiple micro cups, or multiple rotatable balls.

21. The active electronic paper touch apparatus as disclosed in claim 19, wherein said self capacitive touch detection procedure includes a charging step, a charge redistribution step, and a comparison step; said mutual capacitive touch detection procedure includes a signal transmission step and a signal reception step.

22. The active electronic paper touch apparatus as disclosed in claim 21, wherein said capacitive touch detection procedure further includes a reverse bias step.
